(19) United States
(12) Patent Application Publication
(10) Pub. No.: US 2008/0201290 A1
(43) Pub. Date: Aug. 21, 2008

(54) COMPUTER-IMPLEMENTED METHODS, SYSTEMS, AND COMPUTER PROGRAM PRODUCTS FOR ENHANCED BATCH MODE PROCESSING OF A RELATIONAL DATABASE

(75) Inventor: Rajamanickam Ponmudi, Scotch Plains, NJ (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/675,654

(22) Filed: Feb. 16, 2007

(51) Int. Cl. G06F 17/30

(52) U.S. Cl. 707/1

(57) ABSTRACT

Computer-implemented methods, systems, and computer program products for enhanced batch mode processing of a relational database are provided. A computer-implemented method includes creating a sequential file for a relational table in a relational database, receiving an input file and a database query for the relational table, and, if needed, sorting the input file and the sequential file on a primary key or a non-key. The computer-implemented method also includes generating a temporary file for processing the input file and the sequential file and executing an operation for the database query on the sorted input file and the sorted sequential file within the temporary file. The computer-implemented method also includes storing output of the operation in the temporary file and updating the relational table with the output of the temporary file.

### BACKGROUND OF THE INVENTION

The present disclosure relates generally to data processing systems and, in particular, to computer-implemented methods, systems, and computer program products for enhanced batch mode processing of a relational database.

A relational database is a collection of files whereby one or more of the files are related using a common field. Within each file, a primary key is used to uniquely identify each record in the file. The records are typically stored in a serial fashion; that is, in no particular order.

Managing files in a relational database is relatively simple, particularly when used in smaller applications. However, in large-scale relational database management applications where databases store volumes of tables (and where each table may store, e.g., hundreds of thousands, if not millions, of records), ensuring up-to-date information can be difficult as the search/update operations performed on non-key data is likely to become time consuming. For example, an inquiry for a non-key element on a table having 10 million records may take several minutes using a tablespace scan. If the table happens to be one that is partitioned on a key, the inquiry may take even longer. Further, batch mode processing of records using existing techniques, e.g., transaction logging and Page I-O are also time consuming, as well as resource intensive, thereby presenting inefficiencies for large-scale applications.

What is needed, therefore, is a more time-efficient way to implement large-scale relational database management activities including batch processing.

### BRIEF SUMMARY OF THE INVENTION

Embodiments of the invention include computer-implemented methods for enhanced batch mode processing of a relational database. A computer-implemented method includes creating a sequential file for a relational table in a relational database, receiving an input file and a database query for the relational table, and sorting the input file and the sequential file on a primary key or a non-key. The computer-implemented method also includes generating a temporary file for processing the input file and the sequential file and executing an operation for the database query on the sorted input file and the sorted sequential file within the temporary file. The computer-implemented method also includes storing output of the operation in the temporary file and updating the relational table with the output of the temporary file. The sequential file created may include extra bytes of information to include a record reference, update indicator, time stamp, etc. The processing (queries) may also be performed on unsorted files where the end results are sorted based on the requirements. Also, if the input data is already sorted, the sorting step may be bypassed.

Additional embodiments include systems for enhanced batch mode processing of data files. A system includes a computer processing device and an application executing on the computer processing device. The application performs a method. The method includes creating a sequential file for a relational table in a relational database, receiving an input file and a database query for the relational table, and sorting the input file and the sequential file on primary key or a non-key. The method also includes generating a temporary file for processing the input file and the sequential file and executing an operation for the database query on the sorted input file and the sorted sequential file within the temporary file. The method also includes storing output of the operation in the temporary file and updating the relational table with the output of the temporary file. The processing (queries) may also be performed on unsorted files where the end results are sorted based on the requirements. Also, if the input data is already sorted, the sorting step may be bypassed.

Further embodiments include computer program products for enhanced batch mode processing of relational data using sequential files that have been created and maintained. A computer program product includes instructions for causing a computer processing device to implement a method. The method includes creating a sequential file for a relational table in a relational database, receiving an input file and a database query for the relational table, and sorting the input file. The method also includes generating a temporary file for processing the input file and the sequential file and executing an operation for the database query on the sorted input file and the sorted sequential file within the temporary file. The method also includes storing output of the operation in the temporary file and updating the relational table with the output of the temporary file. If the input file is already sorted, the sorting step may be bypassed.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a system upon which enhanced batch mode processing of files may be implemented in exemplary embodiments;

FIG. 2 is a flow diagram describing a process for implementing batch mode processing of files in exemplary embodiments; and

FIG. 3 is a sample sequential file created and utilized by the batch mode processing system in exemplary embodiments.

The detailed description explains the preferred embodiments of the invention, together with advantages and features, by way of example with reference to the drawings.

### DETAILED DESCRIPTION OF THE INVENTION

Computer-implemented methods, systems, and computer program products for enhanced batch mode processing of relational database tables are provided in accordance with exemplary embodiments. The enhanced batch mode processing provides a means for efficiently processing large volumes of data in a relational database management system. The enhanced batch mode processing includes modified query language commands, a sequential file utility, an update propagator, a large volume processing facility (LVPF) and a set of sequential files, each of which correspond to a relational table. The LVPF 110 performs batch processing of relational database records while avoiding conventional transaction logging and Page I-O, which can be very time consuming. As will be understood from the following description, careful design of online applications that invoke enhanced relational database utilities in the background may make the online processing of relational database transactions more efficient, particularly when large volumes of online data is encountered. These, and other advantages of the exemplary embodiments, will now be described.

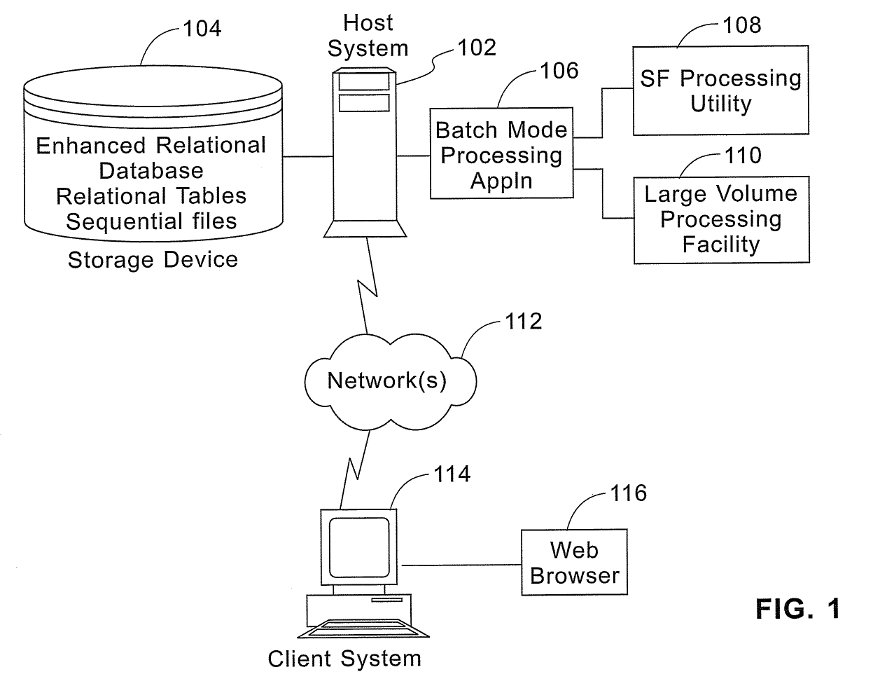

Turning now to FIG. 1, a system upon which the batch mode processing activities may be implemented will now be described in exemplary embodiments. The system of FIG. 1 includes a host system 102 in communication with a storage device 104 and one or more networks 112. The host system 102 executes a database management application (DBMS) such as IBM's® DB2. Host system 102 also implements one or more applications for providing the batch mode processing activities described herein. These one or more applications are collectively referred to herein as batch mode processing application 106.

Host system 102 may be implemented as a high-speed computer processor, e.g., mainframe computer, capable of handling large volumes of transactions. The host system 102 receives query language commands (e.g., Structured Query Language, or SQL) and executes these commands on files/tables stored in storage device 104. For example, commands may include “select”, “insert”, “delete”, etc. To distinguish the conventional relational database processing from the sequential file based processing of relational data, a set of new SQL commands is herein proposed and is referred to herein as ESQL (Enhanced SQL). ESQL commands express the choice of the application to process the relational data in the sequential form. The same concept may also be implemented without using the ESQL commands, but rather following the step-by-step approach using the sequential files associated with relational data.

Host system 102 may be implemented using one or more servers operating in response to a computer program stored in a storage medium accessible by the server(s). The host system 102 may operate as a network server (e.g., a web server) to communicate with a user system (e.g., client system 114). The host system 102 handles sending and receiving information to and from the client system 114 and can perform associated tasks.

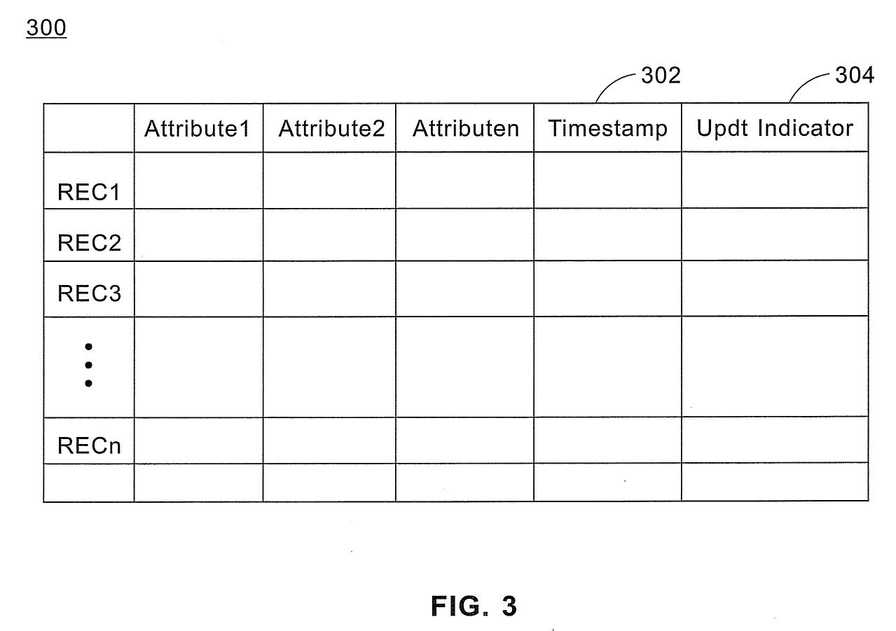

Storage device 104 may be implemented using memory contained in the host system 102 or it may be a separate physical, logical, or virtual device. In exemplary embodiments, the storage device 104 is in direct communication with the host system 102 (via, e.g., cabling). However, other network implementations may be utilized. For example, storage device 104 may be logically addressable as a consolidated data source across a distributed environment that includes one or more networks 112. Information stored in the storage device 104 may be retrieved and manipulated via the host system 102. Storage device 104 stores a variety of information for use in implementing the batch processing activities. As shown in FIG. 1, storage device 104 stores one or more enhanced relational databases (ERDBs), which in turn, include relational tables and sequential files as described further herein. The sequential file created may include extra bytes of information to include a record reference, update indicator, time stamp, etc. An update indicator field 304 and a timestamp field 302 are shown generally in a sequential file 300 illustrated in FIG. 3. The processing (queries) may also be performed on unsorted files where the end results are sorted based on the requirements. Also, if the input data is already sorted, the sorting step may be bypassed. The sequential files may be stored, for processing efficiency, in the form of internal binary representation of the machine.

Client system 114 may be operated by a user at a geographic location who is a representative (e.g., programmer/employee) of the business enterprise operating host system 102. Optionally, the batch mode processing activities includes a web component whereby a user at client system 114 initiates an activity (e.g., query using ESQL) via a web browser application 116 executing on the client system 114 and the web component of the batch mode processing application 106 over networks 112.

Client system 114 may be implemented using a general-purpose computer executing a computer program for carrying out the processes described herein. While a single client system 114 is shown in the system of FIG. 1, it will be understood that many user systems may be implemented in order to realize the advantages of the batch mode processing activities described herein.

Network(s) 112 may be any type of known networks including, but not limited to, a wide area network (WAN), a local area network (LAN), a global network (e.g. Internet), a virtual private network (VPN), and an intranet. The network(s) 112 may be implemented using a wireless network or any kind of physical network implementation known in the art. A user system 114 may be coupled to the host system 102 through multiple networks (e.g., intranet and Internet) so that not all user systems are coupled to the host system 102 through the same network.

The batch mode processing application 106 includes a sequential file processing utility 108 and a large volume processing facility (LVPF) 110. The LVPF 110 performs batch processing of relational database records while avoiding conventional transaction logging and Page I-O, which can be very time consuming. A sequential file processing utility 108 (also referred to herein as SUPERZ utility) is utilized by the batch mode processing application 106 as described further herein. The batch mode processing application 106 also includes an update propagator component (not shown) for ensuring sequential files are in sync with corresponding relational tables.

Processing two sequential files and producing an output file for a given set of criteria is one of the basic needs in sequential file processing. Utilities of this nature can be found in many IT environments as a vendor supplied utility or locally developed utility. Taking an IBM® mainframe environment as an example, these functions can be handled using SuperC utility and DFSORT utility. However, the needs of ERDB are different compared to what SuperC and DFSORT can offer today. Hence, a new utility, SUPERZ utility 108, is provided with various capabilities as will now be described.

For a given master file and match file (where the master file corresponds to a sequential file and the match file corresponds to an input file), the SUPERZ utility 108 creates an output file (also referred to as a temporary file) performing the necessary processing using the command input. For example, assume there are two files FA and FB where FA is the master file and FB is the match file. Suppose that the files have two elements each in which the first data element (e.g., the first column) is the key. Both files have identical record length and are sorted on the key.

FA:

| | |
|---|---|
| 1 | A |
| 2 | B |
| 5 | C |

FB:

| | |
|---|---|
| 3 | D |
| 4 | E |
| 5 | F |
| 6 | G |

There are different ways for processing these two files as described below.

Case 1:

### Run SuperZ Master=FA, Match=FB, KEY 1/1/1 Output=FC Option=INSERT

Here KEY a,b,c is the syntax
where
   ‘a’ is the starting column of the key in master file
   ‘b’ is the length of the key,
   ‘c’ is the starting column of the key in the match file
      The processed output in FC is:

FC:

| | |
|---|---|
| 1 | A |
| 2 | B |
| 3 | D |
| 4 | E |
| 5 | C |
| 6 | G |

Note that the record with key ‘5’ is in the output file (FC) and is unchanged.

Case 2:

Run SuperZ Master=FA, Match=FB, Output=FC KEY 1/1/1 Option=UPDATE The processed output in FC is:

FC:

| | |
|---|---|
| 1 | A |
| 2 | B |
| 5 | F |

Note that the record with key '5 is updated under this option. Records 3, 4, and 6 may be moved into an exception file.

Case 3:

Run SuperZ Master=FA, Match=FB, Output=FC KEY 1/1/1 Option=PROCESS (This option achieves the functions of both INSERT and UPDATE.)
The processed output in FC is:

FC:

| | |
|---|---|
| 1 | A |
| 2 | B |
| 3 | D |
| 4 | E |
| 5 | F |
| 6 | G |

Case 4:

### Run SuperZ Master=FA, Match=FB, Output=FC KEY 1/1/1 Option=DELETE

The processed output in FC is:

FC:

| | |
|---|---|
| 1 | A |
| 2 | B |

Here the record ‘5’ in master is deleted based on the match key ‘5’ in match file.

The deleted record ‘5’ can be moved into an exception file.

Case 5:

### Run SuperZ Master=FA, Match=FB, Output=FC KEY 1/1/1 Option=DELETE REST

The processed output in FC is:

FC:

| | |
|---|---|
| 5 | C |

Records 1 and 2 may be moved into the exception file.

Case 6:

It is assumed that the files FA and FB have one more element, ‘YYYYMM’.

FA:

| | | |
|---|---|---|
| 1 | A | 200501 |
| 2 | B | 200501 |
| 3 | C | 200504 |
| 4 | D | 200504 |

FB:

| | | |
|---|---|---|
| 1 | H | 200502 |
| 2 | I | 200502 |
| 4 | J | 200502 |

### Run SuperZ Master=FA, Match=FB, Output=FC KEY 3/6/3 Option=INSERT

Note that the key starts at the third byte for master and match files and the key length is 6 bytes. Also, there are duplicate records on the given key.
The processed output in FC is:

FC:

| | | |
|---|---|---|
| 1 | A | 200501 |
| 2 | B | 200501 |
| 1 | H | 200502 |
| 2 | I | 200502 |
| 4 | J | 200502 |
| 3 | C | 200504 |
| 4 | D | 200504 |

The examples above are illustrative of the SUPERZ utility 108. This may be further leveraged with the MOVE option as explained in the below examples.

Case 7:

Assume files FA and FB have the following contents:

FA:

| | |
|---|---|
| 1 | A |
| 2 | B |
| 5 | C |

FB: (record length 100 bytes)

| | | |
|---|---|---|
| 2 | D | X |
| 4 | E | Y |
| 5 | F | Z |
| 6 | G | W |

File FB has a record length of 100 bytes and the last byte contains ‘X’ in the first record, ‘Y’ in the second record, and so on.

### Run SuperZ Master=FA, Match=FB, Output=FC KEY 1/1/1 MOVE 2/1/100 OPTION=UPDATE

The output of this processing is:

FC:

| | |
|---|---|
| 1 | A |
| 2 | X |
| 5 | Z |

Here, for the matching record (with key say, ‘2’ in this example), all the input is moved to output, then the contents from column 100 from the match record (one byte) is moved over column 2 of the output record. Thus, the value ‘X’ is moved from column 100 of FB to column 2 of FC.
In this example, if the MOVE command is MOVE 2/1/“T”, then FC is:

FC:

| | |
|---|---|
| 1 | A |
| 2 | T |
| 5 | T |

Here, a fixed value of “T” is being moved into the output records for all of the matches.

Case 8:

FA:

| | |
|---|---|
| 1 | A |
| 2 | B |
| 5 | C |

The master and match file may be the same.

### Run SuperZ Master=FA, Match=FA, Output=FC KEY 1/1/1 MOVE 2/1/“W”

The output is:

FC:

| | |
|---|---|
| 1 | W |
| 2 | W |
| 5 | W |

In the same way,

### Run SuperZ Master=FA, Match=FA, Output=FC KEY 1/1/1 MOVE 2/1/1

The output is:

FC:

| | |
|---|---|
| 1 | 1 |
| 2 | 2 |
| 5 | 5 |

Thus, the SUPERZ utility 108 becomes very effective in its ability to manipulate the master file (FA) with the help of the match file (FB) using different processing options and the ‘MOVE’ option. The MOVE option may be supplemented with other options, such as ADD, SUBTRACT, MULTIPLY, DIVIDE etc.

Case 9:

FA:

| | |
|---|---|
| 1 | 3 |
| 2 | 4 |
| 5 | 2 |

FB: (record length 100 bytes)

| | | |
|---|---|---|
| 2 | D | 5 |
| 4 | E | 1 |
| 5 | F | 4 |
| 6 | G | 6 |

### Run SuperZ Master=FA, Match=FB, Output=FC KEY 1/1/1 ADD 2/1/100 OPTION=UPDATE

The output of this processing is:

FC:

| | |
|---|---|
| 1 | 3 |
| 2 | 9 |
| 5 | 6 |

Here, for the matching record (with key say, ‘2’ in this example), all the input is moved to output, and the contents from column 100 from the match record (one byte) is added to column 2 of the output record. Thus, the value of ‘9’ will be made available in column 2 of FC.

Case 10: Another exemplary option of the SUPERZ utility 108 is the ability to use a user exit, which is a program that includes logic for processing the master, match records and creating the output record. The user exit is supplied with the record contents of master and match files and the user exit sends back processed data that goes directly into the output record.

It will be understood that many other options may be provided and that the above examples are described for purposes of illustration and are not to be considered as limiting in scope.

The SUPERZ utility 108 is again presented below with reference to a practical problem.

For purposes of illustration, it is assumed there is a file (F1) with a record length of 100 bytes and which contains a million records. It is further assumed there is another file (F2) with around 100,000 records and having the same layout as the first file. The requirement is to update a particular field from F2 into F1 for all the matching records. Assume that both files have a common key, e.g., employee number. The employee number starts from column 1 and has 5 bytes length. The address starts from column 11 and has a length of 30 bytes.

The command input to update all the match records into Master file (F1) is:

### Run SuperZ Master=F1, Match=F2, Output=F3 KEY 1,5,1 MOVE 11,30,11 Option=UPDATE

i.e., KEY a,b,c MOVE d,e,f
where
   ‘a’ is the starting column of the key in master file
   ‘b’ is the length of the key
   ‘c’ is the starting column of the key in the match file
   ‘d’ is the starting column of the updated field in the output record
   ‘e’ is the length of the field to be updated from the match record
   ‘f’ is the starting column in match record where the content to be updated is available (This can also be a fixed value where a given fixed value will be moved to all the records destined to be output. The fixed values, for example, may be given as @ADDRESS NOT GIVEN@)

With the functionality of sequential processing available today, this step may not take more than few seconds and is the basis of further discussion on ESQL as described below.

A prerequisite for the SUPERZ utility 108 is that both Master and Match files have been sorted on the keys before the processing starts. If unsorted data is always expected, the first step of the SUPERZ utility 108 is to sort both the files based on the key length specified. Any output of sequence data from the input file should result in the abnormal termination of the job.

It will be understood that the key specified has no correlation to the KEY specified in the relational database environment. The key field in using the SUPERZ utility 108 may be any field in the master and match files based on the requirements of the utility 108. However, there is nothing to prevent the key from being the same as the key used in the relational database for a given table. In fact, the ESQL commands described herein are based on the assumption that the primary key of the table will be used for processing both the master and match files when no KEY is specified in the ESQL command. It is quite likely that most of the benefits of the batch processing activities described herein may be realized simply by using the relational key fields alone.

In addition, suitable options may be developed for handling duplicate records on a given key in master file, match file, or both. For example, if the match file contains duplicates on key, whether to move the first or last or delete all the duplicates etc., may be defined with proper options.

As indicated above, the ERDB is based on the concept that a sequential file is maintained for each relational table present in the relational database. If T1 and T2 are two tables in the RDB, then there will be two sequential files created (one for each table), e.g., ST1 and ST2, and are stored in the ERDB.

An update propagator (ERDB update propagator) of the batch mode processing application 106 collects the updates to the relational tables T1 and T2 and keeps the sequential files (e.g., ST1 and ST2) in sync with the relational tables T1 and T2. In theory as well as in practice, the tables T1, T2 and the files ST1, ST2 may never be in sync at a given point in time (e.g., t1). There may always be a time lag in processing the updates to files ST1 and ST2. Assuming that the files ST1 and ST2 receive updates applied to them by time t2, the difference between t1 and t2 determines how old the data is. If the differences is several hours, it is unlikely that anyone would be interested in using the data from sources ST1 and ST2 in a given RDB environment where there are updates continuously occurring. On the other hand, if the difference between t1 and t2 is only a couple of seconds or milliseconds, then there may be a number of users who would be interested in using the data from sources ST1 and ST2 for inquiry purposes.

By way of example, assume that the table T1 has 10 million rows. An inquiry on table T1 for a non-key data element yielding the result using a tablespace scan may take a couple of minutes. If T1 happens to be a table partitioned on a key, it is quite possible that the SQL will take much more time. However, the same query, if translated into a scan of the file ST1, will offer the results much faster, such as a few seconds. If the sequential file has been designed in such a way that it is stored in multiple generation data groups (GDGs), the results may be even faster.

One concern may be a situation where the data from ST1 is out of sync as compared to T1. However, by waiting several minutes on a tablescan, there is no assurance to the user that the data is in sync with the table T1. Hence, in this case, it may be more advantageous to obtain the data from the source ST1 since it is available faster than the conventional SQL access. If needed, the results may be given with a clear tag indicating that the query is returned from the sequential files. For example, assume that the table T1 has elements E1, E2, and E3, and the data element E3 is not a key element. Assume also that table T1 has 10 million rows and there are only 5 rows with the value ‘ABC’ in column E3. The SQL SELECT E1, E2, E3 from T1 where E3=‘ABC’ may give the results for three rows after several minutes of tablespace scan. However, the same query, when translated into a search on a sequential file, will offer the same result much faster. Utilities such as SORT, SUPERC, etc., are further optimized when used for sequential file processing as the ERDB can make the best use of these utilities.

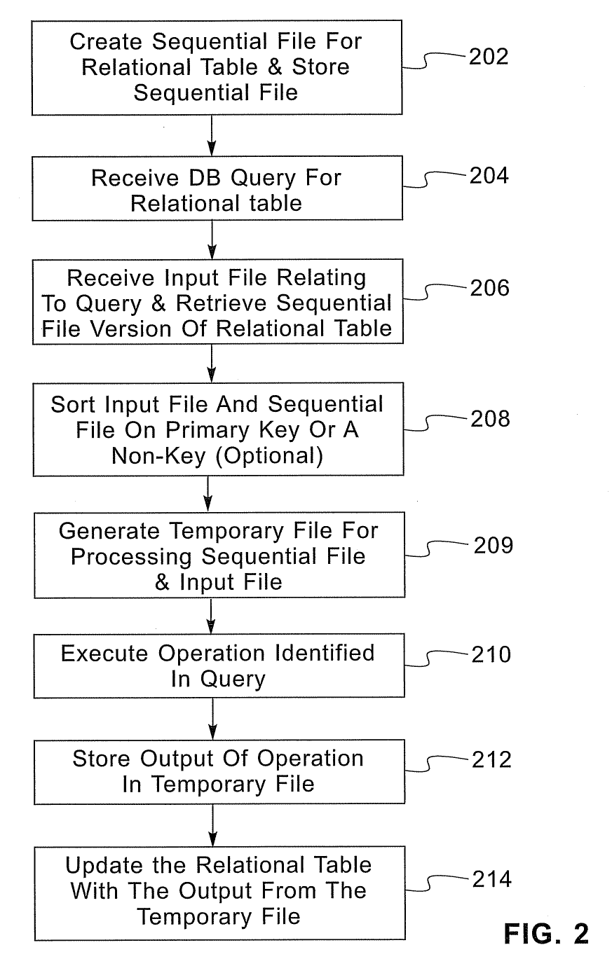

The LVPF utility 110 and the SUPERZ utility 108 will now be described with respect to the flow diagram of FIG. 2 in accordance with exemplary embodiments.

At step 202, a sequential file is created for a relational table T1 (if not already in existence), by the batch mode processing application 106 and stored in the ERDB of storage device 104. A query is received for the relational table T1 at step 204 (e.g., UPDATE, INSERT, SELECT, DELETE, etc.) and the relational table T1 is locked. Data relating to the query is taken as an input file (e.g., match file, or F1) as well as the sequential file version of the relational table T1 for processing at step 206. Based on the needs of the application input, this input file F1 and sequential may be sorted on a key if needed at step 208. It will be understood that the key specified herein has no correlation to the KEY specified in the relational database environment. The key field used in SUPERZ utility 108 may be any field in the master and match files based on the requirements of the SUPERZ utility 108. However, there is nothing to prevent the key from being the same as the key used in the relational database for a given table (e.g., T1). In fact, the ESQL commands described in the examples herein are based on the assumption that the primary key of the table T1 is used for processing both the master and match files when no KEY is specified in the ESQL command. It is quite likely that most of the LVPF benefits may be realized simply by using the relation key fields alone.

The SUPERZ utility 108 generates a temporary file for processing the input file and the sequential file based on the ESQL command at step 209. The SUPERZ utility 108 performs the requested operation (e.g., INSERT, UPDATE, DELETE, etc.) at step 210. The output of the operation performed in step 210 is stored in the temporary file at step 212. The LVPF utility 110 loads the data from the temporary file (i.e., output data) into the corresponding relational table T1 of the ERDB at step 214 using, e.g., DB2 Load utilities. The LVPF utility 110 may also update any indices as needed and the lock is removed from the relational table T1. The sequential files are synced with their corresponding relational tables via the update propagator as described further herein.

A new set of SQL commands are used to implement the batch mode processing activities. This set of commands are similar to the standard SQL statements but with the objective of processing large volume of records in batch mode for a relational database. Each table is assumed to have a sequential file version of the table (or the sequential file is created on an ‘as needed’ basis) by the LVPF 110, and the ESQL (Enhanced SQL) command specifies that the data to be processed is to be retrieved from the sequential files of corresponding relational database tables.

The following ten ESQL statements are shown for illustration.

1. EXEC ESQL INSERT FILE(F1) INTO T1

It is assumed that the file length of input file F1 is 100 bytes with key starting from column 1 with a length of 10 bytes. The relational table T1 has a corresponding sequential file ST1 with a record length of 100 bytes and the key is from columns 1 to 10.
The ESQL command above results in the execution of the following steps (in order):
a. Lock table T1
b. Take the contents of file F1 and the sequential file version (ST1) of table T1. Sort both of them on the primary key field (key lengths can be derived from a data dictionary).
c. RUN SUPERZ Master=ST1, Match=F1, Output=temp KEY 1,10,1 Option=INSERT
a. Load REPLACE the output of SuperZ (File temp) into T1 using DB2 load utility.
b. Build the necessary indexes
c. Remove the table lock on T1.
   If F1 has 100,000 records and T1 has 50,000 new records, the output file (temporary file) will have 150,000 records. An exception report may be generated with details of any duplicate record in the input as the ‘INSERT’ does not expect duplicate records.

2. EXEC ESQL INSERT FILE(F2) INTO T1
a. Lock table T1
b. Take the contents of file F2 and the sequential file version (ST1) of table T1. Sort both of them on the primary key field (key lengths can be derived from data dictionary).
c. RUN SUPERZ Master=ST1, Match=F2, Output=temp KEY 1,10,1 Option=UPDATE
d. Load REPLACE the output of SuperZ (File temp) into T1 using DB2 load utility.
e. Build the necessary indexes
f. Remove the table lock on T1.

3. EXEC ESQL DELETE FILE(F3) FROM T1
a. Lock table T1
b. Sort F3 and ST1 on primary key.
c. RUN SuperZ Master=ST1, Match=F3, Output=temp KEY 1,10,1 OPTION=DELETE
d. Load REPLACE temp file into table T1 using DB2 load utility
e. Build necessary indexes.
f. Unlock table T1
   If T1 has 5000 records and F3 has 1000 records to be deleted, the records to be loaded into T1 using the temp file will be 4000. In this case, the file F3 does not have to be the same length as ST1. As long as the file F3 has the correct key values, the processing will be successful. For example, the file F3 can be a file with a record length of 10 bytes where the key is from column 1 to 10.

4. EXEC ESQL PROCESS FILE (F4) INTO T1

This command involves both INSERT and UPDATE. T1 has 5000 records. File F4 has 1000 records in which 600 are new records and 400 are for update. The final table contents in T1 will be 5600 records with 400 updates done on existing records.

5. EXEC ESQL UPDATE FILE(F1) INTO T1 KEY 1/10/11 MOVE 11,90,21

This is an example where the key in the match file is available from column 11 through 20 and fields to be moved from the match record is 90 bytes from column 21 of the match record.

6. EXEC ESQL SELECT ADDRESS FROM T1 WHEREIN ZIPCODE=‘07076’

Here the file ST1 (master file) will be scanned sequentially to identify all the records with the zip code value ‘07076’ using the data dictionary for the corresponding relational table T1. This type of access may be extremely efficient when the selection is based on a non-key element of the relational database and the table contains a large amount of data.
In this case, the steps involved here include:
a. Lock table T1 (this could be optional if the user does not mind the table being updated during this inquiry)
b. Copy the data from Table T1 into file ST1 and sort it on column 71 thru 75 (assuming the ZIPCODE is present in these columns)
c. Create a sequential file (temp1) with one record with the value ‘07076’ in column 1-5
d. RUN SUPERZ Master=ST1, Match=temp1, output=temp2 KEY 71/5/1 option=DELETE REST
e. The file temp2 has the selected records from T1 for the given inquiry.

7. EXEC ESQL INSERT FILE (SELECT E1,E2,E7,E8,E10 FROM T2) KEY 1/10/1 INTO T1

In this example, relational table T2 has ten columns E1 thru E10. For the sake of simplicity, it is assumed that each column is 10 bytes long. Assuming the relational table T2 is a transaction table, a history table (relational table T1) needs to be updated with the records from T2 into T1. The criterion is that all the records from T2 should be inserted into T1.

The history table (T1) does not contain all the elements of the transaction table. It has only five elements, i.e., E1, E2, E7, E8 and E10 in order. Hence, the sequential file form of the history table will have the record length as 50 bytes. The steps are:
a. Lock table T2 (optional)
b. RUN SQL QUERY: SELECT E1,E2,E7,E8,E10 FROM T2
c. Create a sequential file F1 of 50 bytes using the output of step (b)
d. Lock table T1
e. Take the contents of file F1 (from step c) and the sequential file version (ST1) of table T1.
Sort both the files on KEYS 1/10/1
f. RUN SUPERZ Master=ST1, Match=F1, Output=temp KEY 1,10,1 Option=INSERT
d. Load REPLACE the output of SuperZ (File temp) into T1 using DB2 load utility.
e. Build the necessary indexes
f. Remove the table lock on T1.

8. EXEC ESQL INSERT FILE (EXEC ESQL SELECT * FROM T2) INTO T1 KEY 1/10/1 MOVE 1/20/1 21/10/61 31/10/71 41/10/91

This is same as example (7) but approached in a different way, as follows:
a. Lock table T2 (optional)
b. RUN ESQL QUERY: EXEC ESQL SELECT * FROM T2 (basically a copy of T2 is created here as a temporary file (temp1) with record length 100 bytes)
c. Pass the sequential file ‘temp1’ of 100 bytes from step (b) to the following steps
d. Lock table T1
e. Take the contents of file ‘temp1’ and the sequential file version (ST1) of table T1. Sort both of them using the key specification given i.e., 1/10/1.
f. RUN SUPERZ Master=ST1, Match=temp 1, Output=temp2 KEY 1,10,1 MOVE 1/20/1 21/10/61 31/10/71 41/10/91 Option=INSERT
g. Load REPLACE the output of SuperZ (File temp2) into T1 using DB2 load utility.
h. Build the necessary indexes
i. Remove the table lock on T1.
   It will be noted in this approach, the master record is 50 bytes, the match record is 100 bytes, and the output record is 50 bytes (the 50 bytes of the output record may be created by using different fields of the 100 bytes match record).

9. DELETING AND INSERTING ON A PRIMARY KEY

Here is another example that exploits the potential of the SUPERZ utility 108 in relational database batch processing. It is assumed there is a relational table called DEPT that has DEPT-number and DEPT-description as two columns (5 bytes and 25 bytes as the column size). The sequential file for this table will be 30 bytes in length with DEPT number (which is the primary key in the table) present in columns 1 thru 5 and the description is available from column 6 through 30.

The business requirement here is that some of the DEPT numbers are to be re-classified. The users have given the old and new DEPT numbers in a temp file (F1). The user input is a 10-byte record where columns 1-5 correspond to the old DEPT number and columns 6-10 represent the new DEPT number. Typically, to update this in a relational database table, one has to delete the record first and insert a new record after deletion.
The ESQL command for this requirement is presented below:

### EXEC ESQL UPDATE FILE (F1) INTO DEPT KEY 1/5/1 MOVE 1/5/6

In this case, the following things take place in order:
a. Lock table DEPT and copy the data into a file SF-DEPT
b. Sort SF-DEPT and F1 on keys 1/5/1.
c. RUN SuperZ Master=SF-DEPT, Match=F1, Output=temp KEY 1/5/1 MOVE 1/5/6 OPTION=UPDATE
   Here, for all the matching records, the contents from the master will be moved to the output and then the MOVE rules will be applied. Hence, for each record that matches, the output record will first have the old key in columns 1 thru 5, and then it will be superimposed by the 5 bytes of content from column 6 of the match record. The SUPERZ utility 108 is not concerned with the particular fields that are being manipulated. Thus, when the table is reloaded in this case, effectively the old keys have been deleted and new keys have been inserted in one step. The corresponding step is:
d. Load REPLACE temp file into table DEPT using DB2 load utility
   The command then continues:
e. Build necessary indexes
f. Unlock table DEPT

10. EXEC ESQL INSERT FILE (F1) INTO T1 USER-EXIT (Prog-01)

Here, the program ‘Prog-01’ will be given the input from file F1 for each record to be inserted, and the program will have the freedom to process this entire record before making the record available to be inserted into the temp file. The temp file will be moved into table T1.

A sample business problem and solution is provided below for illustrative purposes.

It is assumed that a relational database has several tables where three of the tables T1, T5 and T6 contain a column DEPT. When there is a business need that calls for a renaming of the DEPT, the technical need is that all the DEPT numbers should be changed from one number to another number. In this case, since the DEPT number is provided in three tables, all of the data in these three tables should undergo a data conversion process that changes the code based on a conversion list.

The following is also assumed for this example: Input file F1 has a record length of 10 bytes and contains the old DEPT number and the new DEPT number both with 5 characters each; relational table T1 has the DEPT number in columns 1 through 5, relational table T5 has the DEPT number in columns 21 through 25, and relational table T6 has the DEPT number from column 31 to 35; the column numbers refer to the column number of the sequential file format of the corresponding table; and the record length of the tables T1, T5, and T6 are 100, 150, and 75, respectively.

The solution for the business problem includes:

### EXEC ESQL UPDATE FILE(F1) INTO T1 KEY 1/5/1 MOVE 1/5/6

### EXEC ESQL UPDATE FILE(F1) INTO T5 KEY 21/5/1 MOVE 21/5/6

### EXEC ESQL UPDATE FILE (F1) INTO T6 KEY 31/5/1 MOVE 31/5/6

The sequential files and update propagator of the batch mode processing application 106 will now be described in exemplary embodiments.

The concept of ESQL calls for doubling the storage space of a given relational database (ERDB). With the benefits in query processing (which involves a large number of non-key records) and the efficiencies of batch processing, it is worth duplicating the data. A number of dependent applications on a given database may find this option (i.e., having a file version of the database table) very useful.

There may be concern that the cost of maintaining the sequential file in sync with the database could be an expensive proposition. If a given table has 100,000 updates a day by online transaction processing, then the sequential file version needs to be updated for these 100,000 updates. However, there are a number of ways to handle this situation. For example, a sequential file version ST1 may be created with two generation data groups (GDGs) where ST1(1) may be the data as of yesterday and ST1(2) may be today's data. Any attempt by ESQL to access the sequential form of table T1 will be offered the data from both of these files.

For example, assume that ST(1) and ST(2) have both a time stamp and an update indicator at the end of their records. Any attempt to access the latest sequential form of table T1 may be given records as follows:

a. all records from ST(1)

b. removed records with ‘D’ (delete indicator) in the update indicator field in ST(2)

c. sort the records from steps (a) and (b) on time-stamp and remove duplicates on the primary key retaining the latest record.

The sequential files have the ability to get records appended at their end. Based on the logic described above, the files ST(1) and ST(2) may also be a single file.

While maintaining the data in sync is relatively an easy exercise, rolling back the updated data out of a sequential file may be an expensive proposition. However, here again there is an easy solution. At a valid sync point decided by the RDB, one may simply delete the sequential file and recreate the entire file from the RDB tables using Copy commands of the RDB utilities.

The sequential files maintained under ERDB principles may be a great benefit to the existing re-org utility where the very first step is to create a sequential file from the relational tables. The sequential files and audit trails can be efficiently designed such that each of them makes the best use of the other.

For tables of small size, e.g., a few thousand records, maintaining an additional sequential file for each of them will not be a big overhead. On the other hand, for tables with a huge volume of records (running into several million), it may be well justified to maintain the sequential file version of the relational table due to e.g., the fast response achieved for inquiries that are of tablespace scan in nature; the ability to update a large volume of records into these tables in an efficient way using ESQL concepts and commands; and improving productivity by using a general purpose update utility instead of writing, compiling, and testing update programs.

There may further be concerns that the sequential files will open up the data for everyone when compared to a conventional relational database where the access is given via views. As long as the relational database has the ownership of the data of Enhanced Relational database, this concern may be addressed automatically, i.e., usage of ESQL commands will tale full advantage of SQL views and related access constraints. Furthermore, existing access protocols (for example, the RACF in the IBM® mainframe computer) may be extended to the sequential files created for the relational data and access can be controlled at each file level.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A computer-implemented method for enhanced batch mode processing of relational data files, comprising:
creating a sequential file for a relational table in a relational database;
receiving an input file and a database query for the relational table;
sorting records in the input file and the sequential file on a primary key or a non-key;
generating a temporary file for processing the input file and the sequential file;
executing an operation for the database query on the sorted records of the input file and the sorted records of the sequential file within the temporary file;
storing output of the operation in the temporary file; and
updating the relational table with the output from the temporary file.

2. The computer-implemented method of claim 1, further comprising synchronizing the relational table and the sequential file to include updated data resulting from the operation, the method further comprising:
a) retrieving all records from the sequential file;
b) removing records from the sequential file where a delete indicator is present in an update indicator field of the record;
c) sorting the records resulting from steps a) and b); and
d) removing duplicate records on the primary key by retaining the most current record of the duplicate records, the most current record determined by a timestamp present in a timestamp field of the record.

3. The computer-implemented method of claim 1, wherein creating a sequential file includes generating two or more generation data groups, each of the two or more generation data groups storing updated records from different time periods;
wherein data from each of the two or more generation data groups is presented in response to the query.

4. The computer-implemented method of claim 1, wherein the database query is an enhanced structured query language command, the enhanced structured query language command specifying that the data to be processed for the operation is retrieved from the sequential file and not from the relational table.

5. The computer-implemented method of claim 1, wherein the operation is at least one of a:
process command;
update command;
move command;
select command;
insert command; and
delete command.

6. The computer-implemented method of claim 1, further comprising creating and maintaining a sequential file for each relational table in the relational database.

7. A system for enhanced batch mode processing of relational data files, comprising:
a computer processing device; and
an application executing on the computer processing device, the application performing a method, comprising:
creating a sequential file for a relational table in a relational database;
receiving an input file and a database query for the relational table;
sorting records in the input file and the sequential file on a primary key or a non-key;
generating a temporary file for processing the input file and the sequential file;
executing an operation for the database query on the sorted records of the input file and the sorted records of the sequential file within the temporary file;
storing output of the operation in the temporary file; and
updating the relational table with the output from the temporary file.

8. The system of claim 7, wherein the application further performs:
synchronizing the relational table and the sequential file to include updated data resulting from the operation, the method further comprising:
a) retrieving all records from the sequential file;
b) removing records from the sequential file where a delete indicator is present in an update indicator field of the record;
c) sorting the records resulting from steps a) and b); and
d) removing duplicate records on the primary key by retaining the most current record of the duplicate records, the most current record determined by a timestamp present in a timestamp field of the record.

9. The system of claim 7, wherein creating a sequential file includes generating two or more generation data groups, each of the two or more generation data groups storing updated records from different time periods;
wherein data from each of the two or more generation data groups is presented in response to the query.

10. The system of claim 7, wherein the database query is an enhanced structured query language command, the enhanced structured query language command specifying that the data to be processed for the operation is retrieved from the sequential file and not from the relational table.

11. The system of claim 7, wherein the operation is at least one of a:
process command;
update command;
move command;
select command;
insert command; and
delete command.

12. The system of claim 7, wherein the application further performs:
creating and maintaining a sequential file for each relational table in the relational database.

13. A computer program product for enhanced batch mode processing of relational data files, the computer program product including instructions for causing a computer to implement a method, the method comprising:
creating a sequential file for a relational table in a relational database;
receiving an input file and a database query for the relational table;
sorting records in the input file and the sequential file on a primary key or a non-key;
executing an operation for the database query on the sorted records of the input file and the sorted records of the sequential file;
generating a temporary file that includes the output of the operation; and
updating the relational table with data in the temporary file.

14. The computer program product of claim 13, further comprising instructions for synchronizing the relational table and the sequential file to include updated data resulting from the operation, the method further comprising:
a) retrieving all records from the sequential file;
b) removing records from the sequential file where a delete indicator is present in an update indicator field of the record;
c) sorting the records resulting from steps a) and b); and
d) removing duplicate records on the primary key by retaining the most current record of the duplicate records, the most current record determined by a timestamp present in a timestamp field of the record.

15. The computer program product of claim 13, wherein creating a sequential file includes generating two or more generation data groups, each of the two or more generation data groups storing updated records from different time periods;
wherein data from each of the two or more generation data groups is presented in response to the query.

16. The computer program product of claim 13, wherein the database query is an enhanced structured query language command, the enhanced structured query language command specifying that the data to be processed for the operation is retrieved from the sequential file and not from the relational table.

17. The computer program product of claim 13, wherein the operation is at least one of a:
process command;
update command;
move command;
select command;
insert command; and
delete command.

18. The computer program product of claim 13, further comprising instructions for creating and maintaining a sequential file for each relational table in the relational database.
